(19) United States
(12) Patent Application Publication
(10) Pub. No.: US 2005/0047433 A1
(43) Pub. Date: Mar. 3, 2005

(54) Physical coding sublayer transcoding

(76) Inventors: Dmitri Rizer, West Windsor, NJ (US); Apoorv Srivastava, Franklin Park, NJ (US); David Spaniol, Hillsborough, NJ (US); Richard Witinski, Fogelsville, PA (US); John Michael Khoury JR., Basking Ridge, NJ (US)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 10/871,164

(22) Filed: Jun. 17, 2004

Related U.S. Application Data
(60) Provisional application No. 60/479,068, filed on Jun. 17, 2003.

(51) Int. Cl. H04L 12/66; H04J 15/00; H04J 3/00

(52) U.S. Cl. 370/464; 370/476

(57) ABSTRACT

Techniques for processing MII data are disclosed. The techniques include encoding MII data using 128B/129B codes for inclusion in a data frame. The techniques further include transmitting the data frame over a transmission medium, and decoding the encoded MII data using 128B/129B codes to extract the original MII data.

### CROSS-REFERENCE TO RELATED APPLICATIONS

This application claims the benefit of U.S. Provisional Patent Application Ser. No. 60/479,068, filed on Jun. 17, 2003, which is incorporated herein by reference.

### TECHNICAL FIELD

This disclosure relates to the design of high-speed packet data transmission systems.

### BACKGROUND

In Ethernet-based systems, packet data transmissions generally use a MII (Media Independent Interface) to transfer data between the MAC (Media Access Control) and PHY (Physical Layer Entity) architectural layers as defined in the IEEE 802.3 specification. Typically, to transport MII data over high-speed transmission mediums, reformatting of the data is required. For example, in Ethernet-based systems, reformatting typically is required at the PCS (Physical Coding Sublayer) layer. In such networks, 8B/10B or 64B/66B coding techniques may be used. Reformatting MII data using either 8B/10B or 64B/66B coding techniques results in a considerable amount of overhead being included in the reformatted data. Furthermore, if forward error correction techniques (FEC) are employed during the reformatting process, additional overhead usually is incurred.

### SUMMARY

Techniques for processing MII data are disclosed. The techniques include encoding MII data using 128B/129B codes for inclusion in a data frame. The techniques further include transmitting the data frame over a transmission medium, and decoding the encoded MII data using 128B/129B codes to extract the original MII data.

Various aspects of the system relate to processing MII packet data for communication over a transmission medium using 128B/129B coding as well as forward error correction.

For example, according to one aspect, a method includes encoding Media Independent Interface data using a 128B/129B block coding procedure, transmitting the encoded Media Independent Interface data over a transmission medium, and decoding the Media Independent Interface data using the 128B/129B block coding procedure.

In some implementations, the method also may include encoding and decoding the Media Independent Interface data using forward error correction.

In various implementations, the method also may include generating a 129-bit block of data using 128 bits of the Media Independent Interface data and at least one control character associated with the Media Independent Interface data. The method may also include generating a 1056-bit forward error correction data frame by combining eight of the 129-bit blocks of data with framing and forward error correction overhead information.

A system, apparatus, as well as articles that include a machine-readable medium storing machine-readable instructions for implementing the various techniques, are disclosed. Details of various implementations are discussed in greater detail below.

In some implementations, one or more of the following advantages may be present. For example, using a 128B/129B block coding procedure with Forward Error Correction in a FEC frame may generate an overhead ratio of approximately 3.125%. This overhead ratio is approximately the same overhead achieved in the standard 64B/66B PCS coding without FEC.

An additional benefit of the system relates to transmission of FEC frame data. For example, the sequence of frame information available for processing may allow for immediate transmission of PCS blocks without the need for buffering the entire frame. In addition, overall latency during the transmission may be reduced. Furthermore, the frame may be transmitted from left to right according to the standard IEEE 802.3 convention.

Additional features and advantages may be apparent from the following detailed description, the accompanying drawings and the claims.

### BRIEF DESCRIPTION OF THE DRAWINGS

FIG. 1 illustrates an example of a packet data transmission system that provides processing of Media Independent Interface data.

FIG. 2 illustrates an example of a 128B/129B PCS block format.

FIG. 3 illustrates an example of a first PCS Sub-Block Coding.

FIG. 4 illustrates an example of a second PCS Sub-Block Coding.

FIG. 5 illustrates an example of a forward error correction frame.

### DETAILED DESCRIPTION

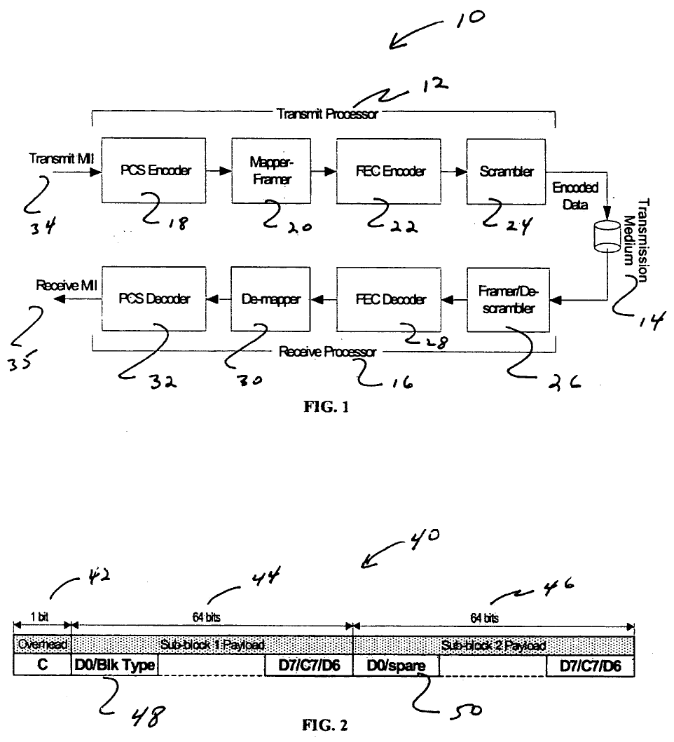

FIG. 1 illustrates an example of a packet data transmission system 10 that provides PHY (Physical Layer Entity) processing of MII (Media Independent Interface) formatted data. The system provides for a low BER (Bit Error Ratio) transmission of input MII data 34 over a serial channel and the subsequent recovery of the original signal. As shown in FIG. 1, the system 10 includes a transmitter such as a processor 12, a transmission medium 14 and a receiver such as a processor 16.

The transmit processor 12 includes a PCS encoder 18, a mapper-framer 20, a FEC (Forward Error Correction) encoder 22, and a scrambler 24. The PCS encoder 18 is a 128B/129B encoder that, for every sixteen bytes of input MII data 34 received, encodes the MII data into 129-bit blocks. Once the MII data is encoded, the PCS encoder 18 transmits the encoded data to the mapper-framer 20. In one implementation, the 129-bit blocks are derived from a single 128B/129B encoder. In other implementations, the 129-bit blocks may be derived from multiple encoders using multiplexing. FIGS. 2, 3 and 4 illustrate examples of the block formats that may be provided by the 128B/129B encoder.

Referring to FIG. 1, the mapper-framer 20 generates a frame based on the 129-bit blocks received from the PCS encoder 18. In one implementation, the mapper-framer 20 combines eight of the 129-bit blocks received from the encoder 18 to generate the frame. In this implementation, each frame generated by the mapper-framer 20 includes two framing bits and twenty-two bits that may be reserved for FEC parity.

The FEC encoder 22 generates and stores parity bits for each FEC frame provided by the mapper-framer 20. In one implementation, the FEC encoder 22 generates parity bits using a BCH (Bose-Chaudhuri-Hochquenghem) algorithm and a generator polynomial of: x²²+x¹⁹+x¹⁶+x¹⁰+x⁸+x⁷+x⁵+x⁴⁺¹. In other implementations, the FEC encoder 22 may use other algorithms to generate parity bits. For example, in one implementation, the FEC encoder 22 may use an RS (Reed-Solomon) algorithm to generate parity bits and store the same in each FEC frame. Once parity bits are generated, the parity bits are stored in the twenty-two bits reserved for FEC parity by the mapper-framer 20 in the FEC frame. FIG. 5 discloses an example of the frame structure generated by the mapper-framer 20 and used by the FEC encoder 22.

Referring to FIG. 1, the scrambler 24 provides the necessary bit timing content and DC balancing (e.g., an equal number of 0s and 1s in the data stream) for clock and data recovery of FEC encoded frames. In one implementation, the scrambler 24 is a frame-synchronous scrambler of sequence length 1024 with a generating polynomial of 1+x³+x¹⁰. In some implementations, the scrambler 24 is a distributed sampling scrambler. In other implementations, other appropriate scramblers can be used.

In one implementation, once FEC encoded frames are received by the scrambler 24, the scrambler resets itself to “all ones” on the first of the twenty-two parity bits received immediately following the two framing bits. These transmitted parity bits, as well as subsequent bits to be scrambled in the FEC encoded frame, are added modulo-2 to the output from the x¹⁰ position of the scrambler 24. The scrambler 24 then performs this process through the entire FEC encoded frame. The two framing bits representing the overhead, however, are not scrambled. In the implementation illustrated in FIG. 1, the scrambler 24 is employed after FEC parity bits are computed and stored in the FEC frame. In other implementations, however, the scrambler 24 may be employed prior to the FEC encoder 22. Once the frame data is scrambled by the scrambler 24, the scrambler transmits the frame data over the transmission medium.

The transmission medium 14 provides a data path for transmitting the frame data to the receive-processor 16. In one implementation, the transmission medium 14 may be glass fiber. In other implementations, the transmission medium may include copper wire, microwave, laser, radio, satellite or other data transportation media.

As shown in FIG. 1, the receive processor 16 includes a framer/de-scrambler 26, a FEC decoder 28, a de-mapper 30 and a PCS decoder 32.

The framer/de-scrambler 26 provides for the de-scrambling and framing of frame data received over the transmission medium 14. In one implementation, the framer/de-scrambler 26 utilizes a frame-synchronous de-scrambler of sequence length 1024 employing a generating polynomial of 1+x³+x¹⁰. Upon receiving the frame data from the transmission medium 14, the framer/de-scrambler 26 resets itself to “all ones” upon receipt of the first of the twenty-two parity bits immediately following the two unscrambled framing bits. This first parity bit, and subsequent bits are then de-scrambled by subtracting modulo-2 the output of the x¹⁰ position of the framer/de-scrambler 26. The framer/de-scrambler 26 then runs continuously through the received frame and de-scrambles the data for the FEC decoder 28.

The FEC decoder 28 corrects bit errors that may occur during transmission of the frame data over the transmission medium 14. Similar to the FEC encoder 22, in one implementation, the FEC decoder 28 employs a BCH algorithm to correct bit errors in the received frame data. In other implementations, the FEC decoder 28 may use other appropriate algorithms (i.e., an RS algorithm) to decode the framed data. Once bit errors are corrected, the FEC decoder sends the bit corrected data to the de-mapper 30.

The de-mapper 30 converts the corrected eight 129-bit blocks received from the FEC decoder 28 into individual 129-bit blocks. In one implementation, the de-mapper 30 removes the two framing bits and twenty-two bits reserved for FEC parity included in the received data to establish individual 129-bit blocks. In implementations that use multiplexing, the de-mapper 30 may de-multiplex the 129-bit blocks received from multiple PCS encoders. Once individual 129-bit blocks of data are reconstituted from the frame data, the de-mapper 30 transmits each 129-bit block to the PCS decoder 32

The PCS decoder 32 converts each of the 129-bit blocks back to original MII format 35 using a 128B/129B block coding procedure with one control bit allocated to every eight bits of data.

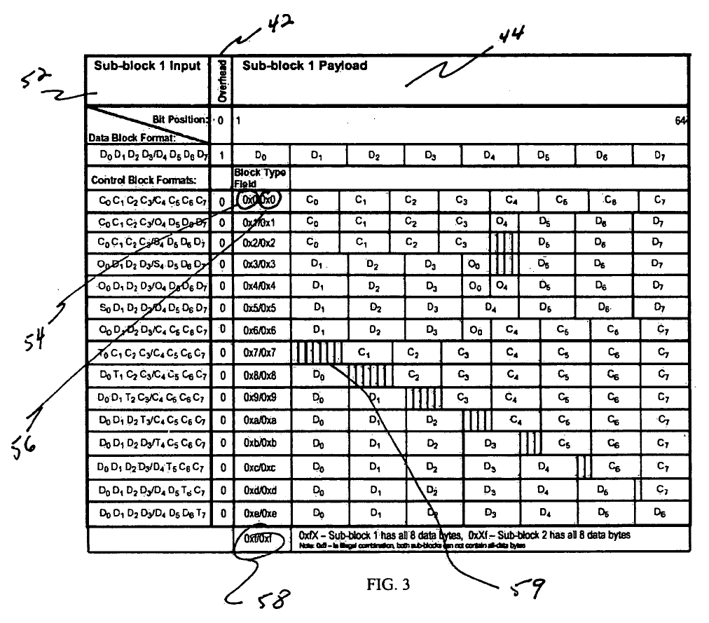

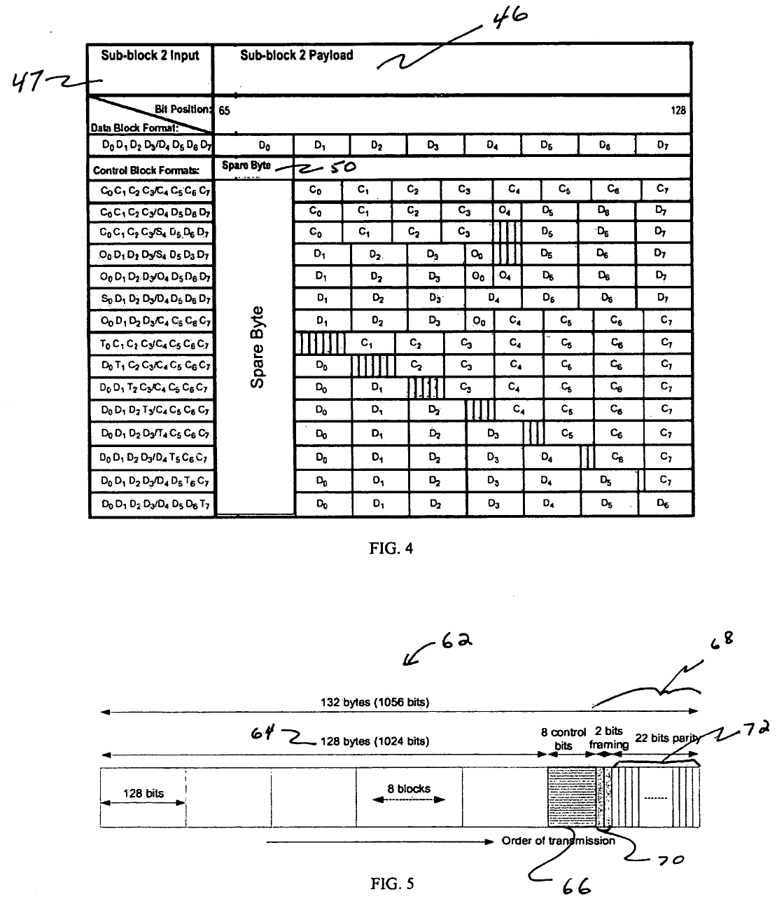

Referring to FIG. 2, an example of the 128B/129B PCS block format 40 generated by the PCS encoder 18 is disclosed. As shown in the FIG. 2 illustration, in one implementation, the coding process employed by the PCS encoder 18 adds one overhead bit 42, labeled ‘C’ in FIG. 2, to every 128-bit block (16 bytes) generated. The overhead bit 42 serves as a control bit that may be used to indicate the presence or absence of MII control information in the 128-bit block. For example, when the overhead bit 42 has a value of ‘1’, all 16 bytes of the block may be considered data. When the overhead bit 42 has a value of ‘0’, at least one or more bytes contained in the PCS block format may contain control information. The coding of the two 64-bit PCS sub-blocks 44, 46 is further illustrated in FIGS. 3 and 4. Except for the block-type byte 48, coding of each of the 64-bit sub-blocks generated by PCS encoder 18 follows the 64B/66B coding technique disclosed in the IEEE 802.3ae specification.

Referring now to FIG. 3, an example of a first PCS sub-block coding is disclosed. As shown in FIG. 3, the column labeled ‘Sub-block 1 Input’ 52 illustrates, in an abbreviated form, the eight characters that may be used to create the 64-bit PCS sub-block 44. These characters are either data characters or control characters. Within the ‘Sub-block 1 Input’ column 52, the values D0 through D7 represent data octets. All other characters in the ‘Sub-block 1 Input’ column 52 are control characters. The single bit fields 59, illustrated as thin rectangles with no label in the ‘Sub-block 1 Payload’ area 44, are sent as zeros and ignored upon receipt by the receive processor 16.

Referring to FIG. 3, the block-type field 48 in the first ‘Sub-block 1 payload’ area 44 includes two independent nibbles (e.g., 4-bit groupings) 54, 56 that are represented in hexadecimal format. The lower nibble 54 (bits 1-4 of the PCS block) defines the first sub-block format and is illustrated in the ‘Sub-block 1 Payload’ area 44 of FIG. 3. In one implementation, for example, if the lower nibble 54 contains zero values, the ‘Sub-block 1 Payload’ area 44 contains all control characters. Similarly, the upper nibble 46 (bits 5-8 of the PCS block) defines the second sub-block format and is illustrated in the ‘Sub-block 2 Payload’ area 46 of FIG. 4.

As shown in the example of FIG. 3, when either the lower or upper nibble 58 contains the value ‘0xf’, the corresponding sub-block payload information contains all-data (e.g., eight data bytes). As a result, assuming that the overhead bit 42 has a value of ‘0’, the PCS decoder 32 identifies a value of ‘0xff’ as being improper for the block-type byte 48 since at least one of the sub-blocks is shown to be a control sub-block.

In one implementation, if the block-type byte 48 contains a value of ‘0xfX’ (e.g., lower nibble is all-ones), the data within the block is rearranged so that the first byte after the overhead bit 42 is a block-type byte having a length of eight data bits. For example, the two Sub-block payload areas 44, 46 may be swapped before being mapped into a frame.

Referring now to FIG. 4, an example of a second PCS sub-block coding is disclosed. As shown in FIG. 4, the codes generated by the PCS encoder 18 and illustrated in the columns labeled ‘Sub-block 2 Input’ 47 and ‘Sub-block 2 Payload’ 46 are similar to the columns labeled ‘Sub-block 1 Input’ 52 and ‘Sub-block 1 Payload’ 44 illustrated in FIG. 3. As shown in FIGS. 3 and 4, however, if the block-type byte 48 disclosed in FIG. 3 does not contain either the value of ‘0xfX’ or ‘0xXf’ (i.e., both Sub-blocks contain control characters), then the first byte of the second sub-block may be considered a spare byte 50. As a result, the spare byte 50 illustrated in FIG. 4 may be available to store a bit pattern. Several advantages may be derived from this implementation. For example, one advantage is that the spare byte may be used for signaling.

Referring now to FIG. 5, an example of an FEC frame structure 62 generated by the mapper-framer 20 and accessed by the FEC encoder 22 is illustrated. The FEC encoder 22 may use a BCH algorithm with 128 bytes (1024 bits) of PCS data 64, one byte of PCS control 66, and three bytes for framing and parity information 68. As shown in the example of FIG. 5, the 1024-bit FEC information field 64 includes eight PCS sets of 129 bits each, plus 2 framing bits. The first 128 bytes 64 hold the eight 128-bit block payload portions of the PCS blocks. A subsequent 129^{th} byte contains the eight control bits 66—one from each of the eight 129-bit PCS blocks in the same order as the 128-bit portions of those blocks in the frame. Three bytes, including two framing bits 70 and twenty-two parity bits 72, complete the 132-byte FEC frame.

Several advantages may be derived from this structure. For example, one advantage is that the sequence of frame information available for processing may allow for immediate transmission of PCS blocks without the need for buffering the entire frame. In addition, overall latency during transmission may be reduced. Furthermore, the frame may be transmitted bitwise from left to right according to the standard IEEE 802.3 convention.

As shown in FIG. 5, the framing pattern generated by the FEC encoder 22 identifies the start of the frame as being 129 bytes in front of the pattern. In one implementation, for example, to improve the DC balancing of the framing signal, the frames may be alternated between odd and even frames and store the values ‘01’ and ‘10, respectively. In other implementations, other bit patterns may be used to denote odd and even frames.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

Other implementations are within the scope of the claims.

1. A method of processing MII (Media Independent Interface) packet data comprising:
encoding Media Independent Interface data using a 128B/129B block coding procedure;
transmitting the encoded Media Independent Interface data over a transmission medium; and
decoding the Media Independent Interface data using the 128B/129B block coding procedure.

2. The method of claim 1 wherein encoding and decoding the Media Independent Interface data comprises using forward error correction.

3. The method of claim 2 wherein using forward error correction comprises using a Bose-Chaudhuri-Hochquenghem algorithm.

4. The method of claim 2 wherein using forward error correction comprises using a Reed-Solomon algorithm.

5. The method of claim 1 wherein using the 128B/129B block coding procedure comprises generating a 129-bit block using 128 bits of the Media Independent Interface data and at least one control character associated with the Media Independent Interface data.

6. The method of claim 5 further comprising generating a data frame by combining at least one of the 129-bit blocks with additional overhead which includes framing information.

7. The method of claim 6 wherein generating the data frame comprises combining forward error correction overhead information with the at least one of the 129-bit blocks and the framing information.

8. The method of claim 7 wherein generating the data frame comprises generating an information field and a parity field.

9. The method of claim 8 wherein generating the information field comprises generating framing bits and Physical Coding Sublayer control and data bits.

10. The method of claim 6 wherein generating the data frame comprises generating a payload-to-frame ratio approximately equal to that of a 64B/66B coding technique.

11. The method of claim 6 wherein generating the data frame comprises generating a payload-to-frame ratio equal to that of a 64B/66B coding technique.

12. The method of claim 2 comprising scrambling the encoded Media Independent Interface data.

13. An apparatus comprising a transmitter to transmit Media Independent Interface data over a transmission medium wherein the transmitter is adapted to encode the Media Independent Interface data using a 128B/129B block coding technique.

14. The apparatus of claim 13 wherein the transmitter is adapted to encode the MII data using forward error correction.

15. The apparatus of claim 14 wherein the transmitter is adapted to use a Bose-Chaudhuri-Hochquenghem algorithm for the forward error correction.

16. The apparatus of claim 14 wherein the transmitter is adapted to use a Reed-Solomon algorithm for the forward error correction.

17. The apparatus of claim 13 wherein the transmitter is adapted to generate a 129-bit block using 128 bits of the Media Independent Interface data and at least one control character associated with the Media Independent Interface data.

18. The apparatus of claim 17 wherein the transmitter is adapted to combine at least one of the 129-bit blocks with additional overhead which includes framing information to generate a forward error correction data frame.

19. The apparatus of claim 18 wherein the transmitter is adapted to combine forward error correction overhead information with the at least one of the 129-bit blocks and the framing information.

20. The apparatus of claim 19 wherein the transmitter is adapted to generate an information field and a parity field in the data frame.

21. The apparatus of claim 20 wherein the transmitter is adapted to generate framing bits and Physical Coding Sublayer control and data bits in the information field.

22. The apparatus of claim 18 wherein the transmitter is adapted to generate a payload-to-frame ratio approximately equal to that of a 64B/66B coding technique.

23. The apparatus of claim 18 wherein the transmitter is adapted to generate a payload-to-frame ratio equal to that of a 64B/66B coding technique.

24. The apparatus of claim 14 wherein the transmitter is adapted to scramble the encoded Media Independent Interface data.

25. An apparatus comprising a receiver to receive Media Independent Interface data from a transmission medium wherein the receiver is adapted to decode the Media Independent Interface data using a 128B/129B block coding technique.

26. The apparatus of claim 25 wherein the receiver is adapted to decode the MII data using forward error correction.

27. The apparatus of claim 26 wherein the receiver is adapted to use a Bose-Chaudhuri-Hochquenghem algorithm for the forward error correction.

28. The apparatus of claim 26 wherein the receiver is adapted to use a Reed-Solomon algorithm for the forward error correction.

29. The apparatus of claim 25 wherein the receiver is adapted to decode a 129-bit block using 128 bits of the Media Independent Interface data and at least one control character associated with the Media Independent Interface data.

30. The apparatus of claim 29 wherein the receiver is adapted to extract at least one of the 129-bit blocks having additional overhead which includes framing information to decode a data frame.

31. The apparatus of claim 30 wherein the receiver is adapted to extract the at least one of the 129-bit blocks having the framing information and forward error correction overhead information.

32. The apparatus of claim 31 wherein the receiver is adapted to decode an information field and a parity field in the data frame.

33. The apparatus of claim 32 wherein the receiver is adapted to decode framing bits and Physical Coding Sublayer control and data bits of the information field.

34. The apparatus of claim 30 wherein the receiver is adapted to decode the data frame at a payload-to-frame ratio approximately equal to that of a 64B/66B coding technique.

35. The apparatus of claim 30 wherein the receiver is adapted to decode the data frame at a payload-to-frame ratio equal to that of a 64B/66B coding technique.

36. The apparatus of claim 26 wherein the receiver is adapted to de-scramble the encoded Media Independent Interface data.

37. A system comprising:
a transmission medium;
a transmitter to encode MII (Media Independent Interface) data using a 128B/129B block coding technique and to transmit the encoded MII data over the transmission medium; and
a receiver to receive the MII transmitted over the transmission medium and to decode the received data using a 128B/129 block coding technique.

38. The system of claim 37 wherein the transmitter and the receiver are adapted to encode and decode the MII data, respectively, using forward error correction.

39. The system of claim 38 wherein the transmitter and the receiver are adapted to use a Bose-Chaudhuri-Hochquenghem algorithm for the forward error correction.

40. The system of claim 38 wherein the transmitter and the receiver are adapted to use a Reed-Solomon algorithm for the forward error correction.

41. The system of claim 37 wherein the transmitter is adapted to generate a 129-bit block using 128 bits of the Media Independent Interface data and at least one control character associated with the Media Independent Interface data.

42. The system of claim 41 wherein the transmitter is adapted to combine at least one of the 129-bit blocks with additional overhead which includes framing information to generate a data frame.

43. The system of claim 42 wherein the transmitter is adapted to combine forward error correction overhead information with the at least one of the 129-bit blocks and the framing information.

44. The system of claim 43 wherein the transmitter is adapted to generate an information field and a parity field in the data frame.

45. The system of claim 44 wherein the transmitter is adapted to generate framing bits and Physical Coding Sublayer control and data bits in the information field.

46. The system of claim 42 wherein the transmitter is adapted to generate a payload-to-frame ratio approximately equal to that of a 64B/66B coding technique.

47. The system of claim 42 wherein the transmitter is adapted to generate a payload-to-frame ratio equal to that of a 64B/66B coding technique.

48. The system of claim 38 wherein the transmitter is adapted to scramble the encoded Media Independent Interface data.

49. The system of claim 37 wherein the receiver is adapted to decode a 129-bit block using 128 bits of the Media Independent Interface data and at least one control character associated with the Media Independent Interface data.

50. The system of claim 49 wherein the receiver is adapted to extract at least one of the 129-bit blocks having additional overhead which includes framing information to decode a data frame.

51. The system of claim 50 wherein the receiver is adapted to extract the at least one of the 129-bit blocks having the framing information and forward error correction overhead information.

52. The system of claim 51 wherein the receiver is adapted to decode an information field and a parity field of the data frame.

53. The system of claim 52 wherein the receiver is adapted to decode framing bits and Physical Coding Sublayer control and data bits of the information field.

54. The system of claim 50 wherein the receiver is adapted to decode the data frame at a payload-to-frame ratio approximately equal to that of a 64B/66B coding technique.

55. The system of claim 50 wherein the receiver is adapted to decode the data frame at a payload-to-frame ratio equal to that of a 64B/66B coding technique.

56. The system of claim 37 wherein the receiver is adapted to de-scramble the encoded Media Independent Interface data.

57. An article comprising a machine-readable medium storing machine-readable instructions that, when applied to the machine, cause the machine to transmit Media Independent, Interface data over a transmission medium using a 128B/129B block coding technique.

58. The article of claim 57 including instructions that, when applied to the machine, cause the machine to encode the MII data using forward error correction.

59. The article of claim 58 including instructions that, when applied to the machine, cause the machine to use a Bose-Chaudhuri-Hochquenghem algorithm for the forward error correction.

60. The article of claim 58 including instructions that, when applied to the machine, cause the machine to use a Reed-Solomon algorithm for the forward error correction.

61. The article of claim 57 including instructions that, when applied to the machine, cause the machine to generate a 129-bit block using 128 bits of the Media Independent Interface data and at least one control character associated with the Media Independent Interface data.

62. The article of claim 61 including instructions that, when applied to the machine, cause the machine to combine at least one of the 129-bit blocks with additional overhead which includes framing information to generate a data frame.

63. The article of claim 62 including instructions that, when applied to the machine, cause the machine to combine forward error correction overhead information to the at least one of the 129-bit blocks and the framing information.

64. The article of claim 63 including instructions that, when applied to the machine, cause the machine to generate an information field and a parity field in the data frame.

65. The article of claim 64 including instructions that, when applied to the machine, cause the machine to generate framing bits and Physical Coding Sublayer control and data bits in the information field.

66. The article of claim 62 including instructions that, when applied to the machine, cause the machine to generate a payload-to-frame ratio approximately equal to that of a 64B/66B coding technique.

67. The article of claim 62 including instructions that, when applied to the machine, cause the machine to generate a payload-to-frame ratio equal to that of a 64B/66B coding technique.

68. The article of claim 58 including instructions that, when applied to the machine, cause the machine to scramble the encoded Media Independent Interface data.

69. An article comprising a machine-readable medium storing machine-readable instructions that, when applied to the machine, cause the machine to receive Media Independent Interface data from a transmission medium and to decode the Media Independent Interface data using a 128B/129B block coding technique.

70. The article of claim 69 including instructions that, when applied to the machine, cause the machine to decode the MII data using forward error correction.

71. The article of claim 70 including instructions that, when applied to the machine, cause the machine to use a Bose-Chaudhuri-Hochquenghem algorithm for the forward error correction.

72. The article of claim 70 including instructions that, when applied to the machine, cause the machine to use a Reed-Solomon algorithm for the forward error correction.

73. The article of claim 69 including instructions that, when applied to the machine, cause the machine to decode a 129-bit block using 128 bits of the Media Independent Interface data and at least one control character associated with the Media Independent Interface data.

74. The article of claim 73 including instructions that, when applied to the machine, cause the machine to extract at least one of the 129-bit blocks having additional overhead which includes framing information to decode a data frame.

75. The article of claim 73 including instructions that, when applied to the machine, cause the machine to extract the at least one of the 129-bit blocks having the framing information and forward error correction overhead information.

76. The article of claim 75 including instructions that, when applied to the machine, cause the machine to decode an information field and a parity field of the data frame.

77. The article of claim 76 including instructions that, when applied to the machine, cause the machine to decode framing bits and Physical Coding Sublayer control and data bits of the information field.

78. The article of claim 74 including instructions that, when applied to the machine, cause the machine to decode the data frame at a payload-to-frame ratio approximately equal to that of a 64B/66B coding technique.

79. The article of claim 74 including instructions that, when applied to the machine, cause the machine to decode the data frame at a payload-to-frame ratio equal to that of a 64B/66B coding technique.

80. The article of claim 70 including instructions that, when applied to the machine, cause the machine to de-scramble the encoded Media Independent Interface data.
